(19) United States
(12) Patent Application Publication
(10) Pub. No.: US 2006/0234717 A1
(43) Pub. Date: Oct. 19, 2006

(54) LISTENING FREQUENCY AND RESOURCE PLANNING FOR CDMA BASED AD-HOC NETWORKS

(75) Inventor: NGAN-CHEUNG PUN, FAIRPORT, NY (US)

Correspondence Address: NGAN-CHEUNG PUN, 98 HAMMOCKS DRIVE, FAIRPORT, NY, 14450, US

(73) Assignee: NGAN-CHEUNG PUN, FAIRPORT, NY (US)

(21) Appl. No.: 11/308,074

(22) Filed: Mar. 6, 2006

Related U.S. Application Data
(60) Provisional application No. 60/659,968, filed on Mar. 9, 2005.

(51) Int. Cl. H04Q 7/20

(52) U.S. Cl. 455/452.2

(57) ABSTRACT

This invention is about a method to reduce the near-far effect in the physical and media access control (MAC) layer for focusing on CDMA radio technologies in ad-hoc network systems. The radio resource is first organized and separated into small pieces, divided in both frequency domain (FDMA) and in time domain (TDMA). Each radio resource is considered as a physical radio channel (PRC). Any node in the network can dynamically allocate it. The near-far effect will be mitigated in each PRC, which is used for supporting a set of CDMA based sub-channels. The selection of the TX and RX PRC depends on which small geographical area (SGA) the node is located. As the nodes in the same SGA share the same PRC as the preferred and designated receiving PRC, power control is possible in a neighborhood of multiple SGA. Each SGA is viewed as a virtual base station regarding a designated PRC as the uplink channel. And each PRC provides a multiple sub-channels via the CDMA method. Adopting this Listening Frequency and Resource Planning (LFRP) can substantially increase the ad-hoc network capacity, by limiting the near-far effect in CDMA channels.

### CROSS-REFERENCE TO RELATED APPLICATIONS

The present Application for Patent claims priority to Provisional Application Ser. No. U.S. 60/659,968, entitled “Listening Frequency Planning for DS-CDMA based Mobile Ad hoc Networks”, filed Mar. 9, 2005.

### FEDERALLY SPONSORED RESEARCH

Not Applicable

### SEQUENCE LISTING OR PROGRAM

Not Applicable

### FIELD OF THE INVENTION

The present invention relates generally to the systems and methods for solving the radio issues of near-far effect and multiple access interference (MAI) in the CDMA based ad-hoc network systems.

### BACKGROUND OF THE INVENTION

Mobile Ad-hoc Network Systems (MANET), an ad hoc network is an autonomous system of mobile stations connected by wireless links. In such a network, each mobile station possesses some routing capabilities. The mobile station may move randomly relative to each other so that the topology may change rapidly and unpredictably. The network must be using one or more of the media access control (MAC) radio technologies for the wireless links. There are many choices of MAC radio technologies such as CDMA, TDMA, and CSMA, etc. And very often, a complex system may combine and mix the use of different MAC radio technologies. For example TD-SCDMA uses both TDMA and CDMA combined. As long as CDMA is concerned, near-far problem is a very critical issue in MANET. Near-far effect is caused by the strong interferences from the near-by users to a weaker desired signal.

In TDMA, the information signal is being sent in a burst with limited time span. Each burst is called a time slot. For any user in the system, it is allowed to send multiple number bursts in a second. In general the burst schedule is organized into time frames and time slots. Each use may have own one time slot in each time frame. TDMA may be an excellent choice of MAC for the Ad-hoc networks because it does not have the near-far problems as the CDMA does but the network capacity, supporting a number of users, is very limited as the number of slots is limited. Combining the TDMA and CDMA technology may increase the number of users in the system. For example, TD-SCDMA is such a scheme and it is being used as one of the 3G standards.

In CDMA, the information signal is encoded with a sequence of bits. The encoding process spreads the output frequency spectrum much wider than the original information signal spectrum. At the same time, different users can communicate sharing the same wide frequency band. The code sequence used should have small cross-correlation with other users. A receiver known the code sequence would be able to retrieve the original information by correlating the code sequence. In general, CDMA has many good properties. It is used for multiple accesses. If a user were transmitting along with other users at the same time, the receiver would be able to retrieve the message from the desired user if the receiver knows the code sequence. However, there is a channel capacity constraint. When more users are added to the system, the noise power will increase and therefore lower the effective SNR at the receiver. CDMA has a good protection against multiple path interference. The signal between the transmitter and the receiver may have come through different paths, direct or reflected. The signal is dispersed in time domain, as multiple delayed copies. Another property of CDMA is that both synchronous and a synchronous demodulation can be employed. In a synchronous demodulation, a code sequence of good auto-correlation, with a narrow single correlation peak can be used to gain timing relations and synchronize channels. While, in synchronous modulation and demodulation, more orthogonal code sequence such as Walsh Code can be used to increase channel capacity. However, CDMA has a critical issue with near-far effect. In practice, the multiple users all share the same wide frequency band, in the same time span, would have cross-correlation noise to each other. A strong near by signal in a close range could overwhelm the weak desired signal and effective block the reception. In the cellular networks, the near-far effect is resolved by power control, coordinated by the base station. In ad-hoc network, there does not exist a centralized base station to maintain the power control to the nodes in the local neighborhood.

Near-far Interference and Power Control, a near-far effect happens, when strong signal from the near by users overwhelms a weak signal reception, usually from a far distance. The problem is particular important for the CDMA based communication systems, where the users share the same radio frequency band. Power control has been extensively investigated for cellular networks. The primary importance of power control is to alleviate the near-far effect, reduce the interferences induced by proximity of multiple users. The goal is to equalize the receiving power from different users. It minimizes the power consumptions, reduces near-far interference and increases the overall system capacity. In a CDMA cellular system, power control is needed for the downlink (base station to mobile station) as well as for the uplink (mobile station to base station). But, power control is more critical for the uplink. The near-far problem is intensified when some mobile stations move close to the base station. Without power control, the strong signal from the close by mobile station will overwhelm the weak signal from the distant mobile stations. As an illustration of how much the power control regulates the mobile transmit power: The minimum and maximum transmitting power ranges from −60 dBm to +30 dBm in a typical CDMA communication system, such as CDMA2000, and IS-95. The dynamic range is about 90 dB. The range difference in signal strength is a difference of a billion times in power levels.

Radio MAC issues with Ad-hoc Networks, in ad-hoc network are more complex than a cellular network system, which has a fixed base station to coordinate the mobile stations in the cell. In an ad-hoc network system, there does not exist a fixed base station to administrate the near by mobile stations. In MANET, for CDMA based MAC, a critical issue is the near-far effect, which cannot be resolved by power control the same way as in cellular networks. For example, the near-far effect can be illustrated in this scenario. A user mobile-A talking to user mobile-B, is required to use full transmission power, while in the close proximity of mobile-A, another user mobile-C is receiving a weak signal from another user mobile-D. The strong transmission signal from mobile-A could be completely overwhelming the weak desired signal for mobile-C.

### SUMMARY OF THE INVENTION

This invention is about a method to reduce the near-far effect in the physical and media access control (MAC) layer for focusing on CDMA radio technologies in ad-hoc network systems. The radio resource is first organized and separated into small pieces, divided in both frequency domain (FDMA) and in time domain (TDMA). Each radio resource is considered as a physical radio channel (PRC). Any node in the network can dynamically allocate it. The near-far effect will be mitigated in each PRC, which is used for supporting a set of CDMA based sub-channels.

A network has topological and spatial aspects. The network is first spatially and virtually divided into small geographical regions (SGA). And each SGA is assigned with a designated, specified receiving PRC. As a listening PRC, it sets a desired receiving power level in the SGA. By following the planning, no nodes in the SGA would be subjected to near-far effect in their receiving signals. This specific PRC of SGA is considered as a listening, or receiving PRC. Any radio can transmit in all available PRC as long as the desired receiving power level of a specific PRC in the SGA is not violated.

This resource-planning scheme is called the listening frequency and resource planning (LFRP). It allows the nodes automatically change their schedule of PRC as they are moving and locating in different SGA. As the result the whole network is not subjected to high levels of near-far interference.

For each PRC, a set of CDMA channels, or called sub-channels can be supported. In fact, the whole LFRP is aiming to pave the use of CDMA sub-channels in the network. The LFRP significantly increases the network density and capacity of the ad-hoc network system and mitigate the near-far effect for CDMA channels.

The PRC is reused over a sufficient spatial separation. If each unique PRC is represented by a unique color, then the tiles of SGA are colored in a certain pattern. The pattern will be repeated as the network spans over a bigger area.

The nodes are aware of which SGA area so that the LFRP can be executed. SGA boundaries and identities can be predetermined in the coordinates of the positioning system.

### BRIEF DESCRIPTION OF DRAWING

FIG. 1 shows that a radio coverage region (RCR) is divided into 3 sub-regions by 2 concentric circles. The innermost region, the area of the smallest circle is defined as a small geographical area (SGA). A SGA region has a specified receiving PRC.

FIG. 2 shows that the SGA is replicated over the regions of a RCR. Each SGA is assigned with a specified PRC as a receiving PRC. The same receiving PRC can be repeated as a good spatial separation.

FIG. 3 has an area of bigger than one RCR. It shows how SGA and assigned PRC can be patterned and arranged so that the spatial separation is good enough the reuse of an identical receiving PRC. Each SGA is respectively the center of a RCR.

FIG. 4 shows the desired receiving power level centered at a SGA is resembling the power control in CDMA based fixed cellular base stations.

FIG. 5 shows a simple example of a fully meshed ad-hoc network in which 2 pairs of nodes are communicating in the network. The figure also illustrates how a node has its interference power span over the distance.

### DETAILED DESCRIPTION

This invention is about a method to reduce the near-far effect in the physical and media access control (MAC) layer for focusing on CDMA radio technologies in ad-hoc network systems. The radio resource is first organized and separated into small pieces, divided in both frequency domain (FDMA) and in time domain (TDMA). Each radio resource is considered as a physical radio channel (PRC). Any node in the network can dynamically allocate it. The near-far effect will be mitigated in each PRC, which is used for supporting a set of CDMA based sub-channels.

Each PRC is described by {Frequency Carrier ID, Time Slot ID}. Each unique PRC has an ID number. When a PRC is used for receiving channel, it is described as a set of parameters, X={PRC ID, desired receiving power level, a set of CDMA sub-channels}. When a PRC is used for a transmitting channel, it is described as a set of parameters, Y={PRC ID, adjustable transmitting power level, a set of CDMA sub-channels}. A PRC is either used for transmit or receive. The receiving end determines the choice of PRC.

When a communication link is first being established between two nodes, a designated common CDMA sub-channel may be employed as a control channel. The use or setup of other CDMA sub-channels can be negotiated via the control channel. A node that intends to broadcast its hello message to all the nodes in the radio coverage region (RCR), the neighborhood, would have to beacon via the designated common CDMA sub-channel in all PRC.

A network has topological (how each node are connected) and spatial (how each node are separated in space) aspects. The network is first spatially and virtually divided into small geographical regions (SGA) and nodes in the same SGA (here the respective SGA is represented as SGA-X) will be using a specified receiving PRC. And all other transmission signals anywhere inside or near the SGA-X must not interfere with the specified PRC. Setting a desired receiving power level (a low level) on the specific PRC in a SGA would mitigate the interference level inside such SGA, while the transmitters can be anywhere in the neighborhood. In other words, all the nodes, regardless wherever in the neighborhood of a SGA (here take SGA-X) would have to seriously control their transmission power on the PRC that is the receiving PRC of SGA-X. They have to make sure that when the signal comes to SGA-X, the power levels must not exceed the desired receiving power level set by SGA-X on the receiving PRC. This specific PRC of SGA-X is considered as a listening, or receiving PRC associated to SGA-X. Any radio can transmit in all available PRC as long as the desired receiving power level of a specific PRC in the SGA is not violated.

Construct and define a small geographical area (SGA): to facilitate the above radio resource planning in ad-hoc networks, a spatial area called RCR (radio coverage region) is defined. RCR is approximately the area of the radio coverage. A node in the center of RCR should be able to communicate with a node at the edge of the RCR. The RCR is then divided into 3 separate sub-regions, separated by 2 concentric circles. The most inner region has a radius of approximately ⅕ of RCR. The middle region has a radius of approximately 3/5 of RCR. The most inner region is called a small geographical area (SGA). SGA is replicated in other parts of the RCR. The middle region of the RCR is composed of approximately 6 SGA and the outer region of RCR is composed of approximately 12 SGA.

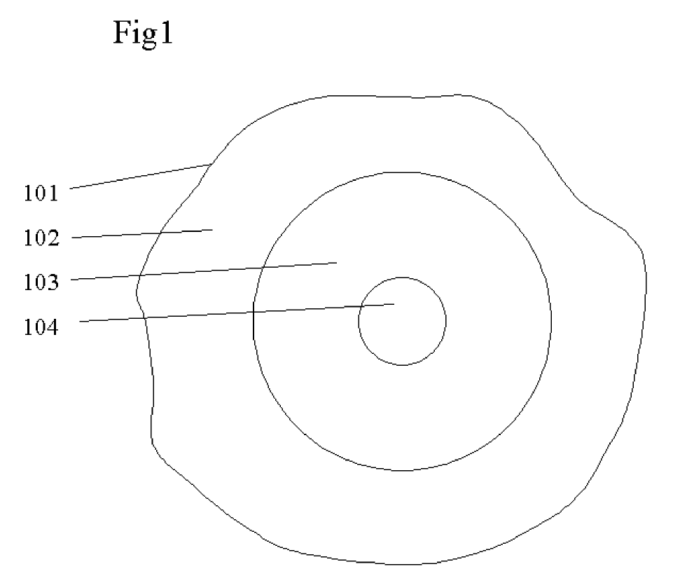

FIG. 1 shows how the size of an SGA is determined from the approximated radio coverage region (RCR) 101. RCR is divided into 3 regions, 102, 103, 104 by 2 concentric circles. The inner region 104 is the center SGA of the RCR. The middle region 103 is providing a spatial separation from the center SGA to the outer region 102.

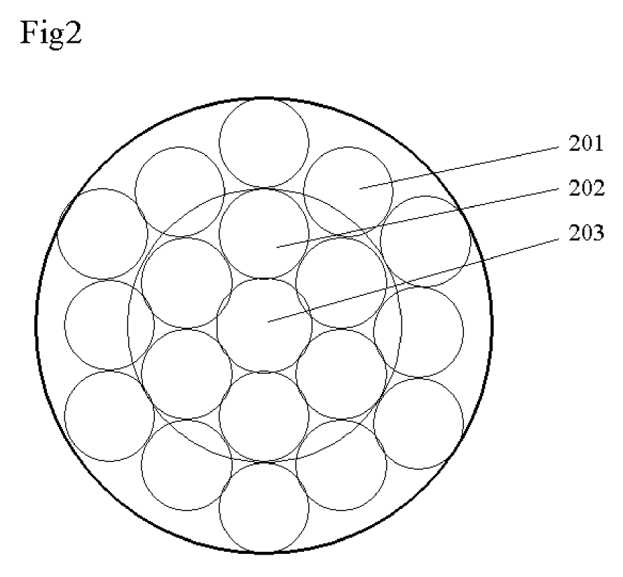

FIG. 2 shows that the center SGA 203 is replicated in the other regions of the RCR. The middle region 202 has about 6SGA and the outer region has approximately 12 SGA.

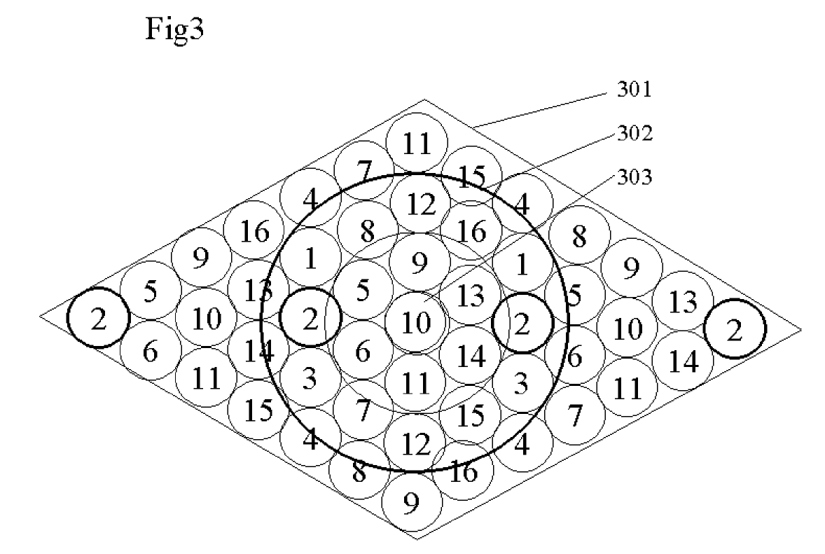

FIG. 3 illustrates the patterns of SGA tiled in a given area. Each SGA has a number to indicate the associated PRC ID. The PRC is reused over a sufficient spatial separation. If each unique PRC is represented by a unique color, then the tiles of SGA are colored in a certain pattern. The pattern will be repeated as the network spans over a bigger area.

Construct the SGA color pattern: each SGA is assigned with a receiving PRC. The PRC ID is represented by a color. For a given SGA, the surrounding SGA would have different colors. The same SGA color can be repeated at a sufficient spatial separation so that near-far interference is minimized. The example in the FIG. 3 shows a separation of 4 SGA units. Notice that each SGA can be viewed as a center SGA.

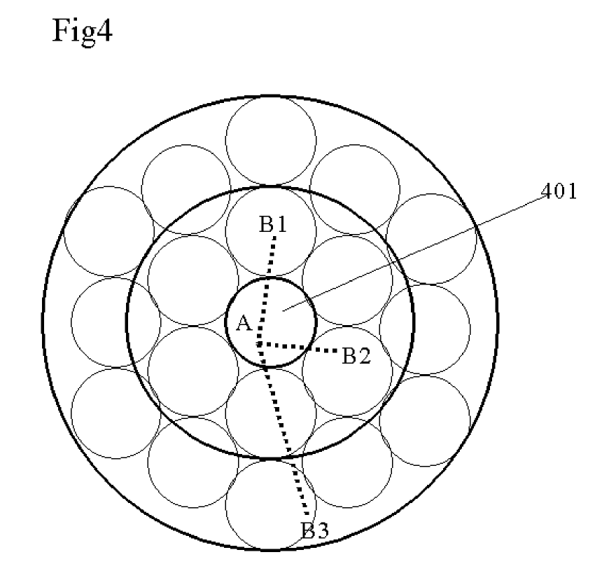

FIG. 4 illustrate the concept that any SGA such as 401 representing the center of a RCR can be viewed as a virtual base station. The RCR is equivalent to the coverage area of a base station. The uplink channels adopted is determined by the receiving PRC of the SGA 401. The downlink channels adopted would depend on the SGA color of the surrounding nodes, such as B1, B2, or B3. The uplink transmitting power is maintained so that nodes in the SGA 401 would not be subjected to a high level of near-far effect.

Scheduling the transmitting and receiving PRC: a node entering a new SGA area would probably see its interference level caused by near-far effect to be increasing. If it would like to reduce the interference level, the best receiving PRC would be the associated PRC of the new SGA. During the transition period, the moving node would begin to negotiate and schedule a change in the receiving channel.

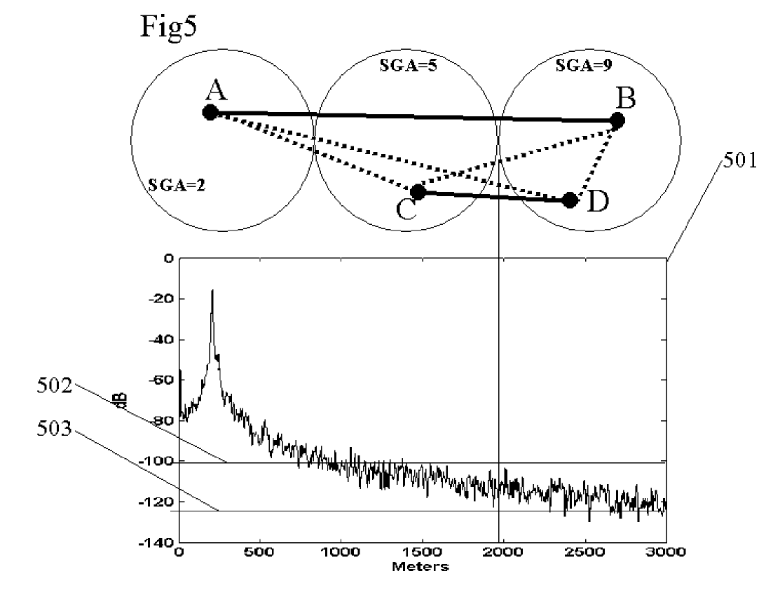

FIG. 5 shows a simple example of a fully meshed ad-hoc network in which 2 pairs of nodes are communicating in the network. The lower part of the figure, 501 also illustrates how node-A has its interference power spans over the distance. In this example, SGA=9 has two nodes B and D sharing the same receiving PRC (denoted by PRC-9). 502 and 503 indicates the desired receiving power level for SGA=9 (or PRC-9). Both node A and node C are transmitting in PRC-9 with separate CDMA sub-channels. Per link analysis is given below:
Link A-B: interfering to node D. Interference is limited.
Link C-D: interfering to node B. Power control on C sets the receiving power at D into the desired power level. And therefore, the interference to B is also reduced to the desired power level.
Link B-A: B is transmitting in PRC-2 (as A is in SGA=2). The signal in PRC-2 has either a different frequency carrier or on a different time slot. There does not exist any meaningful interference to D and C.
Link D-C: D is transmitting in PRC-5 (as D is in SGA=5). The signal in PRC-5 has either a different frequency carrier or on a different time slot. There does not exist any meaningful interference to B and A.

The nodes are aware of which SGA area so that the LFRP can be executed. SGA boundaries and identities can be predetermined in the coordinates of the positioning system. GPS is a common useful example of positioning system. What is claimed is:

1. A method for radio frequency resource planning for a wireless communication system in an ad-hoc network comprising: (a) a set of at least one radio resource divided in both frequency domain (FDMA) and in time domain (TDMA), (b) a positioning system, (c) a set CDMA PN codes, as sub-channels, for concurrent multiple users access.

2. The closure of claim 1 wherein further comprising a radio resource division means for dividing the radio resources into smaller pieces along the frequency domain, and time domain; the division in frequency domain is addressed as a frequency carrier; the division in time domain is addressed as time slots, repeated in time frames; each individual pieces of radio resources is named as a Physical Radio Channel (PRC); said PRC has a set of parameters={frequency carrier ID, time slot ID}; for each PRC, a set of CDMA PN codes are available as sub-channels.

3. The closure of claim 2 wherein further comprising a region division means for dividing the geographical region into small pieces using the said positioning system, such as GPS; the size of a region is approximately the same size as the maximum radio coverage area, is called radio coverage region (RCR); said RCR is further divided into 3 sub-regions separated by 2 concentric circles; the most inner region has an approximate radius of ⅕ of that of the RCR; the middle region has an approximate radius of ⅗ of that of the RCR; the size of the most inner region is named the Small Geographical Area (SGA) unit; in such an arrangement, the middle region is approximately composed of 6 SGA units and the out most region is approximately composed of 12 SGA units; the SGA is color patterned; each SGA is assigned a receiving PRC; a unique PRC is mapped to a color to represent the SGA such that all adjacent SGA do not have the same color; the SGA color can be repeated at a distance of sufficient spatial separations so that the near-far interference level is kept at the desired level.

4. The closure of claim 3 wherein further comprising a radio resource selection means for receiving and transmitting in order to minimize radio interference and CDMA near-far effects; each SGA color is mapped to a unique PRC, with a desired receiving power level as for receiving; for each said PRC there are also a set of sub-channels provision by CDMA PN codes; for each SGA, the receiving power level on the associated PRC are controlled and maintained by all nodes in the neighborhood; all nodes can select the associated PRC to communicate with the nodes in the SGA but the desired receiving power requirement should be not be violated; the selection of transmitting PRC depends on the other end of the communication link; the selection of CDMA PN code as a sub-channel is negotiated between the two ends of the communication link.

5. The closure of claim 4 wherein further comprising a PRC adaptation means for changing the PRC selection according to the local SGA, for which the node is currently located; as a node moves into different SGA region, the color of SGA changes; the node would have to adopt the associated PRC parameters to the new SGA.

6. The closure of claim 5 wherein further comprising a mapping of SGA to the positioning coordinates means for the nodes in the network to identify which SGA they are currently located; by knowing color of the SGA the receiving PRC can be selected; the selection of transmitting PRC depends on the other end of the communication link; the selection of CDMA PN code as a sub-channel is negotiated between the two ends of the communication link.
